(19) United States
(12) Patent Application Publication
(10) Pub. No.: US 2025/0245058 A1
(43) Pub. Date: Jul. 31, 2025

(54) SYSTEMS AND METHODS FOR SCALING COMPUTATION

(71) Applicant: KINAXIS INC., Ottawa (CA)

(72) Inventor: Matthew IMTIAZ, Ottawa (CA)

(73) Assignee: KINAXIS INC., Ottawa (CA)

(21) Appl. No.: 19/040,644

(22) Filed: Jan. 29, 2025

Related U.S. Application Data
(60) Provisional application No. 63/626,301, filed on Jan. 29, 2024.

(51) Int. Cl. G06F 9/50

(52) U.S. Cl. CPC G06F 9/5038; G06F 2209/5011; G06F 2209/506

(57) ABSTRACT

Systems and methods that direct items of incoming work to respective resource lanes. A gatekeeper uses processing rules to send items of work in the resource lanes to a resource pool where compute resources are assigned to work on the items. The processing rules allow for distribution of the work from the resource lanes to the processing pool so as to prevent work starvation and compute resources starvation.

The present application claims the benefit of U.S. Provisional Patent Application No. 63/626,301 filed Jan. 29, 2024, which is expressly incorporated by reference in its entirety herein.

In a synchronized pipeline, compute resources can include a set of nodes that are used to execute a variety of operations. In such a pipeline, a software program (or build) undergoes a set of work which is executed by the nodes. In order for the build to use the compute resources, the build accesses a resource lock. The resource lock restricts access to the entire group of compute resources such that there can be only one consumer of these compute resources at any given time. If the resource lock is not available, the build has to wait for that resource lock to become available. In the context of a synchronized pipeline, only one build can be processed at a time. Furthermore, processing of a build is distributed in the form of several smaller jobs to the various nodes. These jobs are picked up in a first-in, first-out order. When all the nodes have completed their respective tasks, the lock is released, and the results of the work is now complete. The process is repeated: a next build comes in, accesses the resource lock immediately (if its available), distributes work to the compute resources, and so on. However, if another build arrives while a previous build is being processed, the newly-arrived build has to wait until the resource lock (from the previous build) is released.

As a software company grows, so too does its testing requirements. Each new developer needs the capability to validate their work. The problem is that compute resources cannot easily scale with developers. This is especially true when using multiple synchronized pipelines and employing different sets of compute resources for processing different tasks.

There is a general problem of allocating compute resources in an efficient manner, such that there is maximum utilization of the compute resources, and minimization of any idle time.

### BRIEF SUMMARY

The systems and methods disclosed herein demonstrate scaling up a resource pool, thereby enabling maximum efficiency and utilization while minimizing idle time and computational cost.

In one aspect, a system is provided, that includes a processor. The system also includes a memory storing instructions that, when executed by the processor, configure the system to: receive one or more items of work from one or more input sources; apply an input constraint to each item of work; distribute each item of work to a respective resource lane based on the input constraint; release each item of work from its respective resource lane to a resource pool that includes one or more compute resources, in a sequence based on execution of one or more processing rules by a gatekeeper; and assign the one or more compute resources to perform computation on each item released to the resource pool; where implementation of the one or more processing rules prevents work starvation and compute resources starvation.

In the system, the one or more compute resources can be at least one of a node, a virtual machine, a container and a cloud-based resource. In the system, the gatekeeper may implement the one or more processing rules based on a timer. In the system, the gatekeeper may implement the one or more processing rules based on one or more events. The events can include at least one of a push event, a pull event, and completion of assigned work by the one or more compute resources.

In the system, the one or more processing rules can include at least one of: a rule that allows an item to proceed from its respective lane to the resource pool provided that compute resources are available; and a rule that prioritizes release of work from a specific resource lane. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive one or more items of work from one or more input sources; apply an input constraint to each item of work; distribute each item of work to a respective resource lane based on the input constraint; release each item of work from its respective resource lane to a resource pool that includes one or more compute resources, in a sequence based on execution of one or more processing rules by a gatekeeper; and assign the one or more compute resources to perform computation on each item released to the resource pool, where implementation of the one or more processing rules prevents work starvation and compute resources starvation.

In the computer-readable storage medium, the one or more compute resources can be at least one of a node, a virtual machine, a container and a cloud-based resource. In the computer-readable storage medium, the gatekeeper can implement the one or more processing rules based on a timer. In the computer-readable storage medium, the gatekeeper may implement the one or more processing rules based on one or more events. The events can include at least one of a push event, a pull event, and completion of assigned work by the one or more compute resources.

In the computer-readable storage medium, the one or more processing rules can include at least one of: a rule that allows an item to proceed from its respective lane to the resource pool provided that compute resources are available; and a rule that prioritizes release of work from a specific resource lane. Other technical features may be readily apparent to one skilled in the art from the following figures, descriptions, and claims.

In one aspect, a computer-implemented method is provided, that includes: receiving, by a processor, one or more items of work from one or more input sources; applying, by the processor, an input constraint to each item of work; distributing, by the processor, each item of work to a respective resource lane based on the input constraint; releasing, by the processor, each item of work from its respective resource lane to a resource pool that includes one or more compute resources, in a sequence based on implementation of one or more processing rules by a gatekeeper; and assigning, by the processor, the one or more compute resources to perform computation on each item released to the resource pool, where implementation of the one or more processing rules prevents work starvation and compute resources starvation.

In the computer-implemented method, the one or more compute resources can be at least one of a node, a virtual machine, a container and a cloud-based resource. In the computer-implemented method, the gatekeeper can implement the one or more processing rules based on a timer. In the computer-implemented method, the gatekeeper can implement the one or more processing rules based on one or more events. The events can include at least one of a push event, a pull event, and completion of assigned work by the one or more compute resources.

In the computer-implemented method, the one or more processing rules can include at least one of: a rule that allows an item to proceed from its respective lane to the resource pool provided that compute resources are available; and a rule that prioritizes release of work from a specific resource lane. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for scaling computation in accordance with one embodiment.

FIG. 2 illustrates system architecture in accordance with one embodiment.

FIG. 3 illustrates a block diagram in accordance with one embodiment.

FIG. 4 illustrates an example of scaling computation in accordance with one embodiment.

FIG. 5A-FIG. 6C illustrate sequences of scaling computation with reference to FIG. 4.

FIG. 5B illustrates an aspect of the subject matter in accordance with one embodiment.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit that includes custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

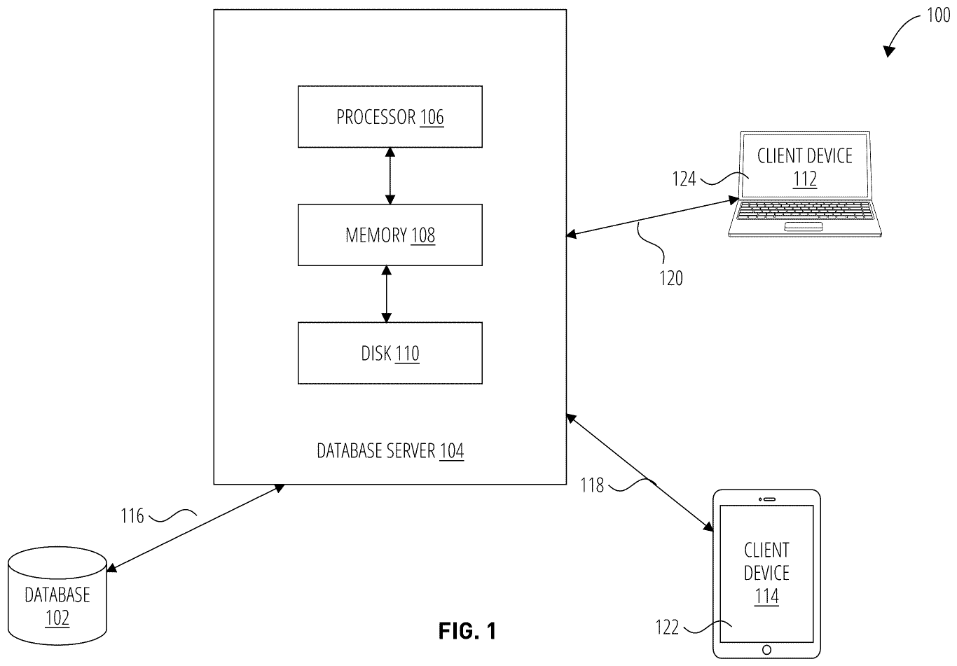

FIG. 1 illustrates an example of a system 100 for scaling computation.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

The systems and methods disclosed herein address the technical problem of scaling up a resource pool, while enabling maximum efficiency and utilization and minimizing idle time and cost.

In general, complex pipelines can have a set of multiple input streams—that is, different items of work from different sources which arrive at an uneven pace. Each input stream includes a set of inputs; each input can be composed of discrete non-uniform computational work of unknown computational cost. An example includes software tests. The term “computational cost” may refer to the amount of computational resources (such as time, memory and processing power) required to execute an algorithm or perform a task. In addition, there is a set of compute resources that perform computations on the work. The technical problem is how to allow each input stream shared access to the compute resources such that: (a) there is no work starvation; (b) there is no compute resource starvation; and (c) both compute resources and workload can be scaled up without breaking rules (a) and (b). Work starvation refers to a situation where there are one or more instances of work that are seeking compute resources, but will never be given any compute resources due to their priority. Resource starvation refers to a situation where there are one or more compute resources that are seeking work, but will never be given any work even though new work is made available.

A technical solution to the technical problem can include input constraints, resource lanes, processing rules, a gatekeeper, and a resource pool.

Input Constraints. These are defined as conditions applied to incoming work to sort the work into distinct groups (or “inputs”) that are placed into respective resource lanes. An example of an input constraint includes a target operating system. Examples of input work can include different sets of tests against one build, or different builds for different operating systems.

Resource Lanes. Incoming work is queued into a particular resource lane, based on the input constraints. Each resource lane leads to the resource pool. An example of resource lanes includes one resource lane for Windows® tests and another resource lane for Linux® tests.

A Resource Pool is defined as a set, or collection, of compute resources that are assigned to the work in the resource lanes. The compute resources perform computation on the assigned work. Furthermore, there can be different types of compute resources within a resource pool. Example of compute resources can include worker nodes, virtual machines (VMs), Docker® containers, etc.

Processing Rules. This is defined as a set of rules that control how many work items are allowed to be sent to the resource pool from each resource lane. Poorly-defined processing rules can lead to work starvation or compute resource starvation. Furthermore, a processing rule may be unique to a resource lane or it may be shared by multiple resource lanes.

A Gatekeeper is defined as a process that has knowledge of queued and running work. The gatekeeper acts as an orchestrator which uses the processing rules to allow work to proceed out of each resource lane and access the resource pool. When the gatekeeper executes a set of properly-implemented processing rules, each processing rule takes into account the available work in queue, which resource lanes the work is in, as well as how much work from each resource lane is being processed. The gatekeeper can implement the processing rules based on events. Examples of events include a compute resource finishing its assigned work and signaling availability, or an entirely separate process controlling when work begins. The events can be “push” notifications from external events and/or “pull” based on an internal decision. An example of a push event includes triggering the gatekeeper when work enters a resource lane. An example of a pull event includes triggering the gatekeeper based on a timer.

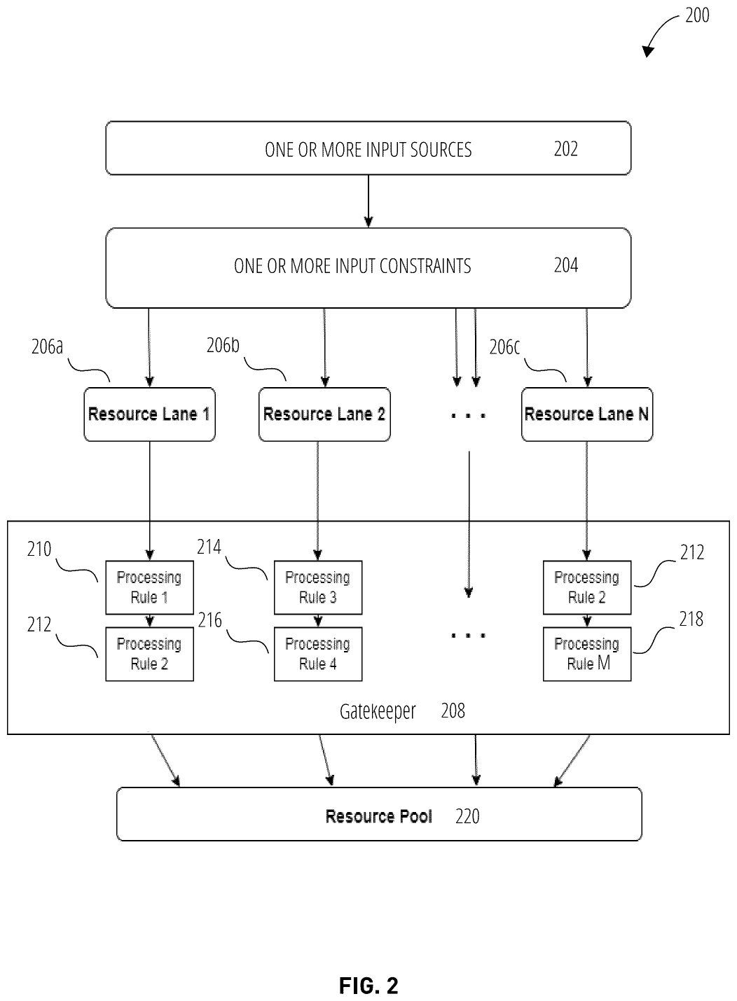

FIG. 2 illustrates a system architecture 200 in accordance with an embodiment. System architecture 200 can include: one or more input sources 202; one or more input constraints 204; one or more resource lanes (206a-206c), a gatekeeper 208, one or more processing rules (210 218), and resource pool 220.

In FIG. 2, for example, there are ‘N’ (N≥1) resource lanes: resource lane 1 (item 206a), resource lane 2 (item 206b), . . . , resource lane N (item 206c). Furthermore, there are ‘M’ (M≥1) processing rules: processing rule 1 (item 210), processing rule 2 (item 212), processing rule 3 (item 214), processing rule 4 (item 216), . . . , processing rule M (item 218).

One or more input sources 202 sends work (that is to be done). Input constraints 204 are defined to distribute the incoming work into one or more different resource lanes (206a-206c). In the embodiment shown in FIG. 2, there are ‘N’ resource lanes. Gatekeeper 208 applies the processing rules defined for each resource lane. Note that some processing rules can apply only to one resource lane, whereas other processing rules may apply to multiple resource lanes. In FIG. 2, for example, processing rule 2 (item 212) applies to both resource lane 1 (item 206a) and resource lane N (item 206c). As incoming work is directed to its respective resource lane, gatekeeper 208 uses the processing rules to determine when the gatekeeper can send a next item of work to resource pool 220.

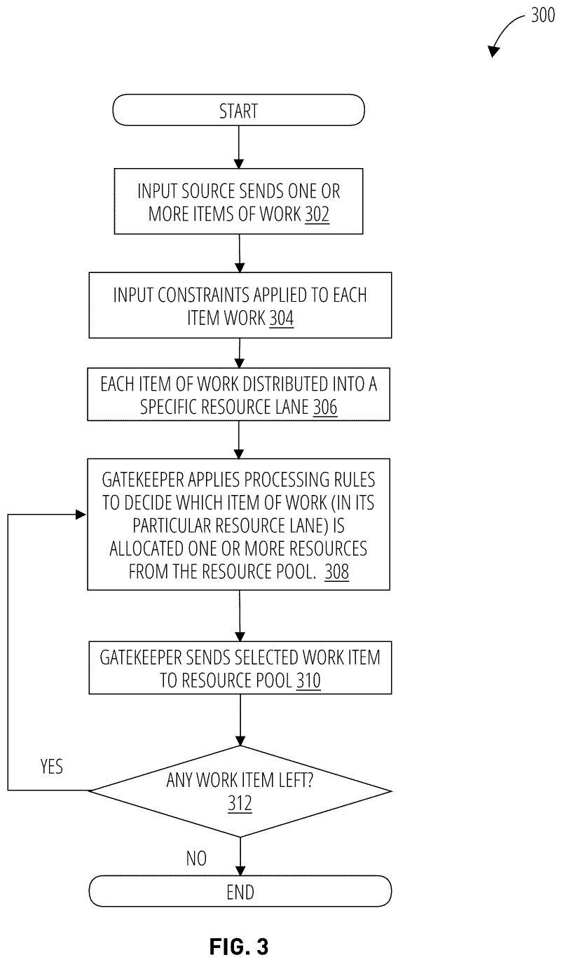

FIG. 3 illustrates a block diagram 300 in accordance with an embodiment for scaling computation

At block 302, an input source provides one or more items of work for which compute resources are required. Next, at block 304, a set of pre-defined input constraints is applied to each item of work as it is supplied from the input source. Application of the input constraints sorts the work item into a respective resource lane at block 306. Subsequently, at block 308, a gatekeeper examines: all of the resource lanes for queued work; the resource pool for work being currently operated on; and the resource pool for available compute resources. The gatekeeper then applies the processing rules to decide which item of work in a resource lane proceeds to the resource pool.

For example, with reference to FIG. 2, a work item W₁ arrives in resource lane 1 (item 206a), while compute resources are busy with other work items in resource pool 220. Gatekeeper 208 runs through processing rules 210 and 212 (as applied to W₁ in resource lane 1), and either one of the two following occurs: processing Rules 210 and 212 allow gatekeeper 208 to take work item W₁ out of resource lane 1 (item 206a) into resource pool 220 where compute resources perform work on W₁; or other work is in progress in resource pool 220 and processing rules 210 and 212 have defined a condition that keeps the work item W₁ in queue in resource lane 1 until other work in resource pool 220 has been completed.

Returning to block diagram 300, at block 310, the selected work item is eventually sent to the resource pool. The gatekeeper checks to see if there are any work items left in the resource lanes at decision block 312. If there are, then the gatekeeper once again applies the processing rules as outlined in block 308 and repeats the process until there are no work items left (‘no’ at decision block 312), and thus the process ends.

This is technically an asynchronous process. When there is a trigger to process a build, that task is not immediately executed. Instead, there is the creation of a promise of work to be done, which, in some embodiments, can be represented by files on disk. A separate folder is created for each type of work; that is, each resource lane may be represented by a folder on disk. That is, each folder represents a resource lane queue. For example, in the case of three types of builds, there are three distinct folders on disk. In general, for each type of build, there can be a corresponding distinct folder on disk.

These resource lane folders can be considered as a staging area for jobs that require processing. These resource lanes can be thought of as akin to lanes of traffic. However, it is up to the gatekeeper to allow each job through its respective resource lane. In this way, there is control over which jobs get through and which jobs have compute resources assigned first. In this manner, there is control which prevents work and compute resource starvation that could occur otherwise. The actions of the gatekeeper are informed by the processing rules.

When the gatekeeper decides to take work from the queue at some future point, it is allocated to the compute resources. That is, the compute resources pick up jobs that have been allocated as soon as the compute resources become available. The compute resources roll over from one build to the next as soon as jobs become available.

The gatekeeper's actions are informed by the processing rules. A set of effective processing rules keeps the compute resources as busy as possible, while preventing each of the resource lanes from being starved of compute resources. In order to accomplish this, the processing rules use partial or complete information about the content of each resource lane at any given time, as well as information about the working status of the resource pool, in order to efficiently guide compute resources to work that should be prioritized.

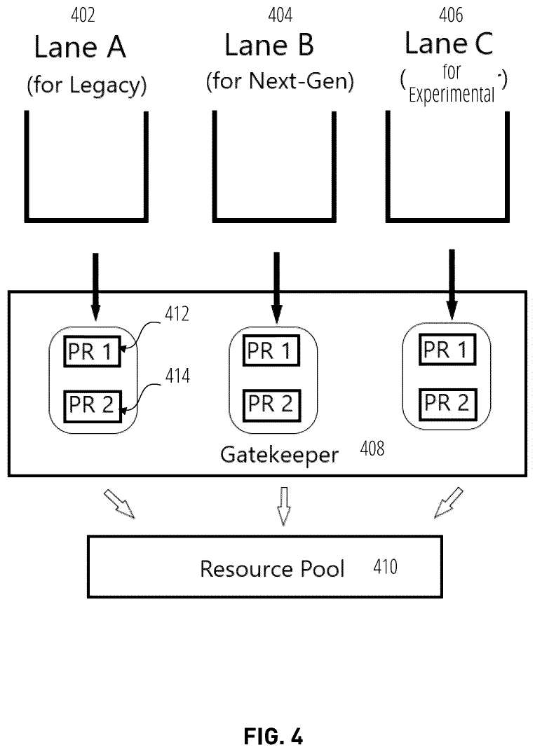

Fair usage of resources can be achieved by the use of resource lanes. In some embodiments, each resource lane corresponds to a type of build that arrives in a pipeline. In an example illustrated in FIG. 4, input work includes previous-generation (i.e. legacy) builds, next-generation (or “next-gen”) builds, and experimental builds. As such, there are three resource lanes: one for next-gen builds, one for legacy builds, and one resource lane for experimental builds. The resource lane for legacy builds can be designated as Lane A 402; the resource lane for next-gen builds can be designated as Lane B 404, and the resource lane for the experimental build can be designated as Lane C 406. There are two processing rules in this example. “Processing Rule 1” dictates that a build can only proceed from its resource lane to the resource pool when there are available compute resources. “Processing rule 2” dictates that work from lane B will always be taken to the resource pool before work from any other lane. In FIG. 4, “Processing Rule 1” is shown as “PR 1” (412), while “Processing Rule 2” is shown as “PR 2” (414). Each of the two processing rules (412 and 414) is applied to each of the three resource lanes (Lane A 402, Lane B 404 and Lane C 406).

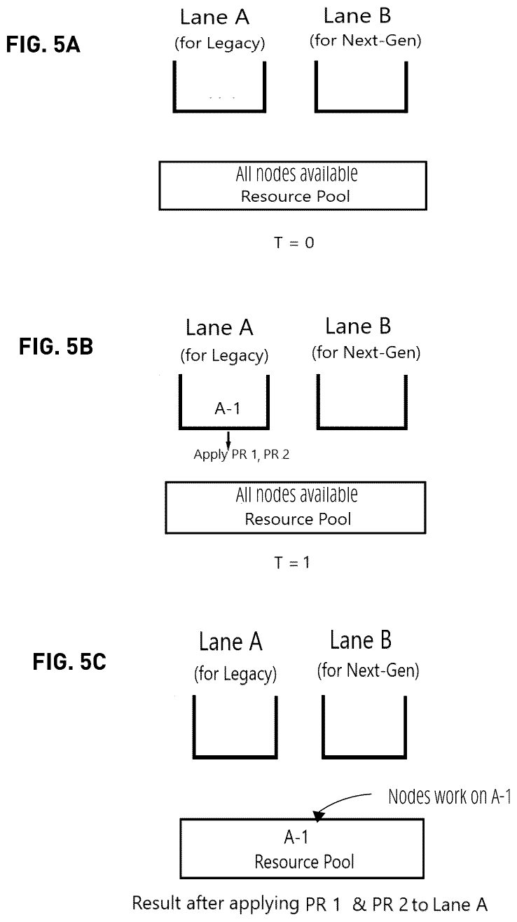

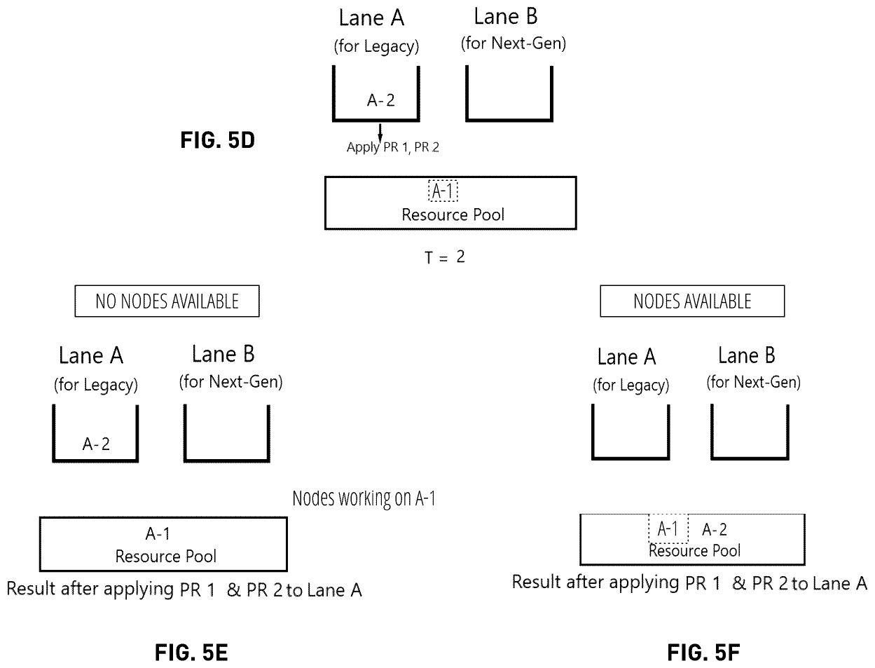

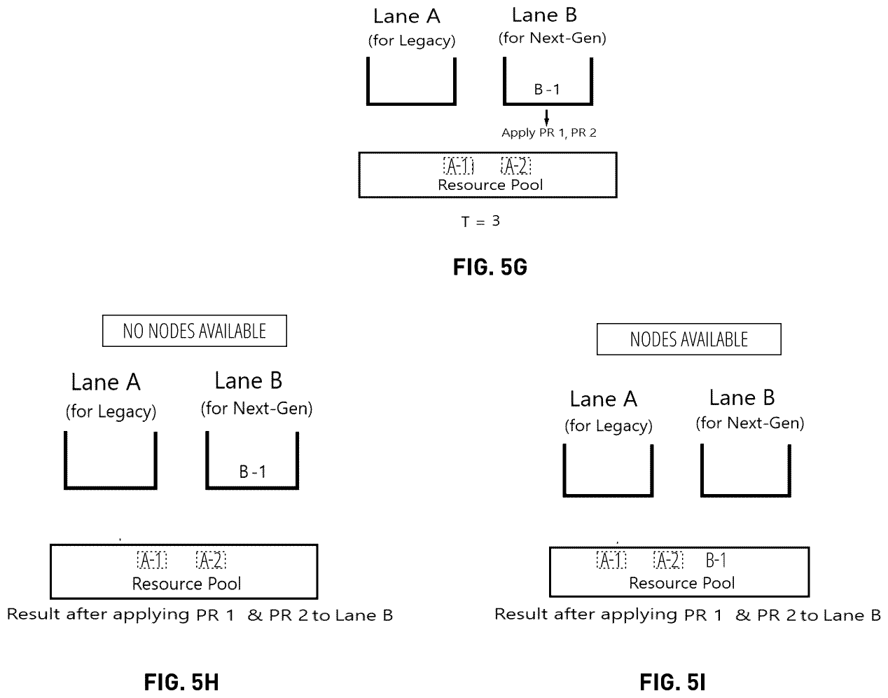

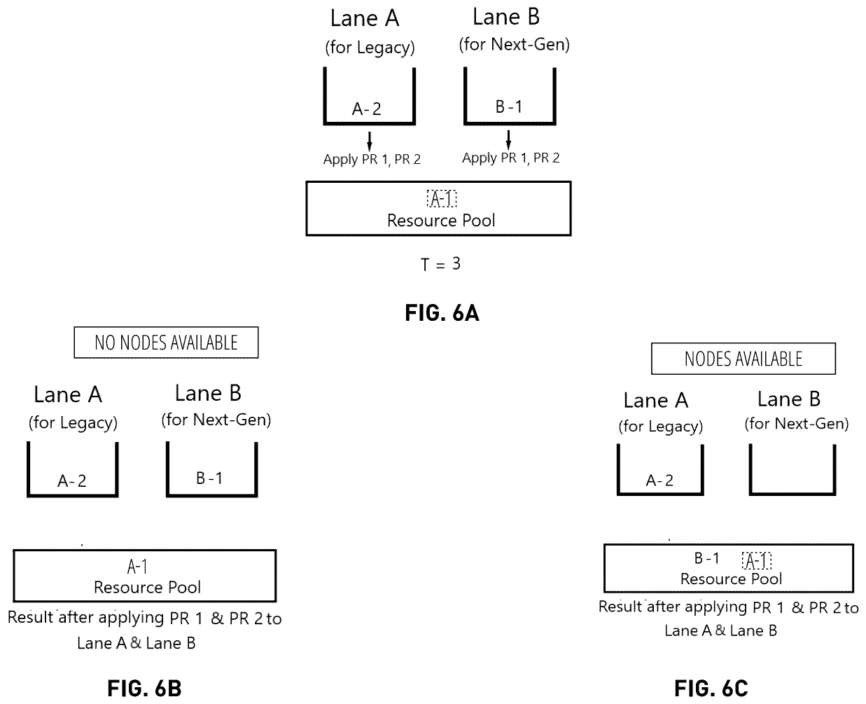

FIG. 5A-FIG. 6C illustrate various sequences of the gatekeeper 408 sending legacy builds (from Lane A) and next-gen builds from Lane B to the resource pool 410. In the example sequence shown in FIG. 5A-FIG. 5B, the gatekeeper 408 operates on a timer, that is, at regularly-timed intervals. In the example sequence shown in FIG. 5A-FIG. 6C, the resource pool 410 includes nodes that operate on each of the builds.

As shown in FIG. 5A, at the start (T=0), all resource lanes are empty. The gatekeeper 408 has not operated yet. All nodes are fully available in the resource pool 410.

In FIG. 5B, the gatekeeper begins operation at T=1. At this time a first legacy build “A-1” has arrived in Lane A. All nodes are available in the resource pool. Processing rules PR 1 and PR 2 are applied to Lane A. Since there are no builds in Lane B, only PR 1 applies. Since nodes are available, the gatekeeper sends A-1 to the resource pool where nodes will operate on A-2. This is shown in FIG. 5C.

In FIG. 5C, nodes work on different jobs that make up A-1. For example, A-1 includes 250 jobs; a separate node works on each job. If there are 355 nodes in the resource pool, 250 of those nodes work on the 250 jobs, leaving 105 nodes available for work. On the other hand, if there are 155 nodes in the resource pool, all 155 nodes work on A-1, leaving no free nodes. As each node finishes its job, it becomes available to work on one of the remaining jobs in A-1; the nodes roll over until the work on A-1 is complete.

FIG. 5D illustrates the situation at T=2, when the gatekeeper makes its regular sweep of the lanes and the resource pool. At T=2, the gatekeeper finds that another legacy build (called “A-2”) is in resource lane A. The gatekeeper also looks at the resource pool to see if there are nodes available. It is possible that the work on A-1 has been completed, or not (thus, A-1 is marked in a dashed box). The gatekeeper applies PR 1 and PR 2 to Lane A. There are two possible outcomes for A-2, depending on the availability of resources in the resource pool.

If no compute resources are available to work on Build A-2, this build is not yet allocated to the resource pool due to Processing Rule 1. This is illustrated in FIG. 5E, where A-1 is still in the resource pool, and all nodes are assigned to A-1 (leaving no free nodes to work on A-2). In this manner, there is no resource starvation, nor work starvation.

On the other hand, if nodes are available, the gatekeeper sends A-2 to the resource pool (in accordance with PR 1), where the available nodes begin to work on A-2. This is illustrated in FIG. 5F, where A-2 is being worked on by the available nodes. It is possible that A-1 is still being worked on in the resource pool. The nodes work on separate jobs in A-2 (and A-1 if its processing is incomplete); a node rolls over to a new job (if available) once it completes its assigned job. In this manner, there is no resource starvation, nor work starvation.

Proceeding from FIG. 5F (in which A-2 has been moved to the resource pool), FIG. 5G illustrates the situation at T=3, when the gatekeeper makes its regular sweep of the lanes and the resource pool. At T=3, the gatekeeper finds that a next-gen build (called “B-1”) is in resource lane B. Furthermore, the gatekeeper scans the resource pool to see if nodes are available. The gatekeeper applies PR 1 and PR 2 to Lane B. There are two possible outcomes for B-1, depending on the availability of nodes in the resource pool. At T=3, it is possible that A-1 and/or A-2 are still in the resource pool, being worked on by the nodes, or that neither A-1 nor A-2 is present in the resource pool. Thus, A-1 and A-2 are each marked in a dashed box. Whatever the situation of A-1 and A-2, the gatekeeper looks to see if nodes are available to work on B-1.

If no nodes are available to work on B-1, this build is not yet allocated to the resource pool due to Processing Rule 1. This is illustrated in FIG. 5H. Here, A-1 and/or A-2 are in the resource pool, being worked on by all the available nodes, thus leaving no nodes free to work on B-1. In this situation, there is more work than there are compute resources. In this manner, there is no resource starvation, nor work starvation.

On the other hand, if nodes are available, the gatekeeper sends B-1 to the resource pool (due to PR 1), where the available nodes begin to work B-1. This is illustrated in FIG. 51, where B-1 is being worked on by the available nodes in the resource pool. It is possible that A-1 and/or A-2 are also present in the resource pool, if their respective jobs have not yet been completed. Or neither A-1 nor A-2 are present, if the nodes have completed their work on A-1 and A-2. Thus each of A-1 and A-2 are marked in a dashed box. The nodes work on separate jobs in each of the builds present in the resource pool; a node rolls over to a new job (if available) once it completes its assigned job. As seen in FIG. 51, a next-gen build can be processed concurrently with one or more legacy builds. In this manner, there is no resource starvation, nor work starvation.

FIG. 6A-FIG. 6C illustrate sequencing of events proceeding from FIG. 5E, in which A-2 remains in Lane A due to the lack of available nodes. FIG. 6A illustrates the situation at T=3, when the gatekeeper makes its regular sweep of the lanes and the resource pool. At T=3, the gatekeeper finds that a next-gen build (called “B-1”) is in resource lane B, along with the presence of A-2 in Lane A. Furthermore, the gatekeeper scans the resource pool to see if nodes are available. The resource pool may still have nodes working on A-1, or not (thus A-1 is in a dashed box). The gatekeeper applies PR 1 and PR 2 to both Lane A and Lane B. PR 2 stipulates that build B-1 should be processed before any build in Lane A. Thus, after applying the processing rules to Lane B, there are two possible outcomes for B-1, depending on the availability of nodes in the resource pool.

If no nodes are available to work on B-1, this build is not yet allocated to the resource pool according to Processing Rule 1. This is illustrated in FIG. 6B. Here, A-1 is in the resource pool, being worked on by all the available nodes, thus leaving no nodes free to work on B-1. In this situation, there is more work than there are compute resources. In this manner, there is no resource starvation, nor work starvation.

On the other hand, if nodes are available, the gatekeeper sends B-1 to the resource pool (in accordance with PR 1), where the available nodes begin to work B-1. This is illustrated in FIG. 6C, where B-1 is being worked on by the available nodes in the resource pool. It is possible that A-1 is also present in the resource pool, if its jobs have not yet been completed. Or A-1 is not present, if the nodes have completed their work on A-1. Thus A-1 is marked in a dashed box. The nodes work on separate jobs in each of the builds present in the resource pool; a node rolls over to a new job (if available) once it completes its assigned job. As seen in FIG. 6C, a next-gen build can be processed concurrently with one or more legacy builds. In this manner, there is no resource starvation, nor work starvation.

In summary of the sequences shown in FIG. 5A-FIG. 6C, when a build arrives for processing, it is immediately queued into its respective resource lane. At some point later, the gatekeeper checks the queue and lets a build through an open resource lane by allocating compute resources (from the resource pool) to that work. Alternatively, the gatekeeper does not allow any build through to the resource pool if all of the compute resources are busy. In this manner, there is no resource starvation, nor work starvation. The actions of the Gatekeeper are informed by the processing rules.

In some embodiments, there can be a pipeline for Windows® work and Linux® work. Two resource lanes are set up: one exclusively for Windows® work, and the other exclusively for Linux® work. In a situation where, for example, hundreds of hours of Windows® work are present, whereas a one single hour of Linux® work is present, should all of the Windows® tests be processed first, and then the lone Linux® test? The Gatekeeper, based on the processing rules, decides which tests should be processed in which sequence. There can be different types of processing rules, so as to suit the objectives of the pipeline in an efficient manner.

In the following example, there are four resource lanes, such that input constraints sort incoming work into four distinct resource lanes: (1) work that runs on Windows® quickly, (2) work that runs on Windows® slowly, (3) work that runs on Linux® quickly, and (4) work that runs on Linux® slowly.

The processing rules of the gatekeeper can include the following: 1) a rule such that the compute resources can only perform computation on one item of slow work at a time; 2) a rule that indicates that slow work starts first (so it can finish sooner) ahead of fast work; 3) a rule that indicates only half the compute resources can work on an item of slow work at a time; and 4) a rule that allows an item of work to the resource pool if there are free compute resources.

Initially, there is the following collection of work: 90 items of quick work that run on Windows®, and 3 items of slow work that run on Windows®. Therefore, at the outset, lanes 1 and 2 are occupied, whereas lanes 3 and 4 are empty. The first item of slow work (from lane 2) is allowed first access to the compute resources in accordance with processing rule 2. However, only half the compute resources in the resource pool are assigned to work on the item of slow work, in accordance with processing rule 3.

Next the gatekeeper allows the first item of fast work in queue in lane 1, to access the available compute resources, in accordance with processing rule 4. Since only half the compute resources are allowed to perform on one item of slow work at a time, the other half of the compute resources begin to work on the item of quick work. A few moments later, the quick Windows® work item finishes (while the item of slow Windows® work is still in progress). It is also possible that as work progresses on the first item of quick work, compute resources become available, thus allowing another item of fast work to be sent through to the resource pool. That is, compute resources can work on more than one item of fast work at a time.

The gatekeeper, according to the processing rules, then allocates the free compute resources to the next item of quick work for Windows® which is in queue in lane 1, and so on. The reason why an item of quick work is sent ahead of an item of slow work is because processing rule 2 does not allow having two items of slow work in the resource pool at once. This sequence repeats until the one item of slow work for Windows® is finished. By this time, 30 items of fast work have been completed.

The gatekeeper, through the processing rules, sees that the resource pool is free of slow work, that half the compute resources available, and that two items of slow work for Windows® are waiting to be processed in lane 2. The gatekeeper then sends the first item of slow work in queue in lane 2 to the resource pool, and allocates half the compute resources to work on this item of slow work for Windows®.

At this point there are 60 items of quick work for Windows® still in queue (in lane 1) and one more item of slow work for Windows® still in queue (in lane 2). Then the following Linux® work comes in: 50 items of quick Linux® work (in lane 3) and 2 items of slow Linux® work. Additional gatekeeper processing rules define the order (between Windows® and Linux®) that the work will be processed. The additional rules can include the following examples.

Example 1: First-in-First-out (FIFO), in which work is processed according to its time of arrival in its respective resource lane. In this situation, since all of the Windows® work arrived prior to all of the Linux® work, all the Windows® work in both lanes 1 and 2 (that is slow, and quick) are processed before starting the Linux® work.

Example 2: Interleaved. FIFO can result in many hours/days for Windows® work to complete before starting the Linux® work. An interleaved processing rule enforces alternating consumption between Windows® and Linux® lanes, so that work in the Linux® lanes is not waiting for all of the Windows® testing to finish. Interleaved processing rules can be advantageous when there are, for example, far more work for Windows®, but relatively little work for Linux® (that is, where there are rare instances of one type of work).

Example 3: Rare work proceeds first. In this set of processing rules, the work that arrives the least often proceeds first, in order to get them out of the way. For example, dozens or hundreds of Windows® tests can be delayed until the few Linux® builds are processed. If the more frequent work is done first, work starvation may occur, where Linux® work never gets picked up because there is always more Windows® work to do.

In some embodiments, the input constraints can be modified to increase the resource lanes. For example, there can be two resource lanes: (1) one for Windows® and (2) one for Linux®. The input constraints can be modified so that each lane can be split for fast and slow work, thereby providing the following four resource lanes: (1) Windows® slow work, (2) Windows® fast work, (3) Linux® slow work, and (4) Linux® fast work. Each of these four resource lanes can be further split into work that uses internet and work that does not use internet, leading to the following 8 resource lanes: (1) Windows® slow work that uses internet, (2) Windows® slow work that does not internet, (3) Windows® fast work that uses internet, (4) Windows® slow work that does not internet, (5) Linux® slow work that uses internet, (6) Linux® slow work that does not internet, (7) Linux® fast work that uses internet, and (8) Linux® slow work that does not use internet. In an example, with the 8 resource lanes, the processing rules can be configured such that those compute resources that have access to the internet execute the work that requires internet access; however if there is no work that requires internet access, the compute resources can begin executing work that does not require internet, thereby allocating the compute resources in an efficient manner and preventing compute resource starvation.

Systems and methods disclosed herein are an improvement over synchronized pipelines. The total throughput is no longer affected by individual run times of the compute resources (which is the case in synchronized pipeline). Instead, the total throughput is affected only by the throughput of individual resource lanes. That is, for example, a slow legacy build slows down the throughput of other legacy builds, but does not prevent the processing of other build types that have their own respective resource lane.

The use of resource lanes, a gatekeeper, and a lockless pipeline provide a large improvement in the overall throughput over a synchronized pipeline. For example, with a synchronized pipeline, it took 3 hours to process two builds. Upon moving to the systems and methods disclosed herein, three builds were processed in 1.5 hours, which is an increase in efficiency of 150%.

Recall that the total throughput in a synchronized pipeline is determined by the longest item of work for each type of build. However, that constraint no longer affects the processing of other builds in the systems and methods disclosed herein. Now, slower processing for work in one lane does not affect the throughput of the other lanes. The systems and methods disclosed herein result in the reduction of idle time, since any time a compute resource is available, it is assigned new work to do.

The use of resource lanes scales up well with additional resources. In a synchronized pipeline, the waste of new compute resources exceeded the gain because the throughput was limited by the slowest item of work. In the systems and methods disclosed herein, 1000 nodes were added and the total throughput of the pipeline kept increasing since the efficiency ceiling was not determined by the number of compute resources, but rather, by the setup time of each job.

The systems and methods disclosed herein can also support the easy addition of more compute resources when the work queue is growing faster than it can be consumed. At any time, cloud resources can be accessed and added to the resource pool. These can assist in running work until a queue is reduced enough, after which, those workers (in the cloud resources) can be deallocated without any disruption to the pipeline. In the cloud, if there is no more work to do, the compute resources can shut down after execution (rather than remain idle and incur costs).

With this design, the throughput of the pipeline is rendered so efficient that further builds are supported for testing on these compute resources. As workload and development teams expand, more compute resources can be added. In one example, an original pool of nodes had been expanded to more than 20 times its original size, and these nodes were shared across eight resource lanes representing major categorizations of builds, tests, and other work.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
receive one or more items of work from one or more input sources;
apply an input constraint to each item of work;
distribute each item of work to a respective resource lane based on the input constraint;
release each item of work from its respective resource lane to a resource pool comprising one or more compute resources, in a sequence based on execution of one or more processing rules by a gatekeeper; and
assign the one or more compute resources to perform computation on each item released to the resource pool,
wherein execution of the one or more processing rules prevents work starvation and compute resources starvation.

2. The system of claim 1, wherein the one or more compute resources are at least one of a node, a virtual machine, a container and a cloud-based resource.

3. The system of claim 1, wherein the gatekeeper implements the one or more processing rules based on a timer.

4. The system of claim 1, wherein the gatekeeper implements the one or more processing rules based on one or more events.

5. The system of claim 4, wherein the events include at least one of a push event, a pull event, and completion of assigned work by the one or more compute resources.

6. The system of claim 1, wherein the one or more processing rules comprise at least one of:
a rule that allows an item to proceed from its respective lane to the resource pool provided that compute resources are available; and
a rule that prioritizes release of work from a specific resource lane.

7. A non-transitory computer-readable storage medium, the computer-readable storage medium including instructions that when executed by a computer, cause the computer to:
receive one or more items of work from one or more input sources;
apply an input constraint to each item of work;
distribute each item of work to a respective resource lane based on the input constraint;
release each item of work from its respective resource lane to a resource pool comprising one or more compute resources, in a sequence based on execution of one or more processing rules by a gatekeeper; and
assign the one or more compute resources to perform computation on each item released to the resource pool,
wherein execution of the one or more processing rules prevents work starvation and compute resources starvation.

8. The computer-readable storage medium of claim 7, wherein the one or more compute resources are at least one of a node, a virtual machine, a container and a cloud-based resource.

9. The computer-readable storage medium of claim 7, wherein the gatekeeper implements the one or more processing rules based on a timer.

10. The computer-readable storage medium of claim 7, wherein the gatekeeper implements the one or more processing rules based on one or more events.

11. The computer-readable storage medium of claim 10, wherein the events include at least one of a push event, a pull event, and completion of assigned work by the one or more compute resources.

12. The computer-readable storage medium of claim 7, wherein the one or more processing rules comprise at least one of:
a rule that allows an item to proceed from its respective lane to the resource pool provided that compute resources are available; and
a rule that prioritizes release of work from a specific resource lane.

13. A computer-implemented method comprising:
receiving, by a processor, one or more items of work from one or more input sources;
applying, by the processor, an input constraint to each item of work;
distributing, by the processor, each item of work to a respective resource lane based on the input constraint;
releasing, by the processor, each item of work from its respective resource lane to a resource pool comprising one or more compute resources, in a sequence based on implementation of one or more processing rules by a gatekeeper; and
assigning, by the processor, the one or more compute resources to perform computation on each item released to the resource pool,
wherein implementation of the one or more processing rules prevents work starvation and compute resources starvation.

14. The computer-implemented method of claim 13, wherein the one or more compute resources are at least one of a node, a virtual machine, a container and a cloud-based resource.

15. The computer-implemented method of claim 13, wherein the gatekeeper implements the one or more processing rules based on a timer.

16. The computer-implemented method of claim 13, wherein the gatekeeper implements the one or more processing rules based on one or more events.

17. The computer-implemented method of claim 16, wherein the events include at least one of a push event, a pull event, and completion of assigned work by the one or more compute resources.

18. The computer-implemented method of claim 13, wherein the one or more processing rules comprise at least one of:
a rule that allows an item to proceed from its respective lane to the resource pool provided that compute resources are available; and
a rule that prioritizes release of work from a specific resource lane.
